(19) United States
(12) Patent Application Publication
(10) Pub. No.: US 2007/0084725 A1
(43) Pub. Date: Apr. 19, 2007

(54) Oxygen sensor

(75) Inventors: Shoichi Sakai, Gunma (JP); Keiji Mori, Gunma (JP); Futoshi Ichiyanagi, Gunma (JP); Akira Uchikawa, Gunma (JP); Masami Kawashima, Gunma (JP); Masao Tsukada, Gunma (JP)

Correspondence Address: SUGHRUE MION, PLLC, 2100 PENNSYLVANIA AVENUE, N.W., SUITE 800, WASHINGTON, DC, 20037, US

(73) Assignee: Hitachi, Ltd.

(21) Appl. No.: 11/580,899

(22) Filed: Oct. 16, 2006

(30) Foreign Application Priority Data
Oct. 19, 2005 (JP) 2005-304378

(51) Int. Cl. G01N 27/26

(52) U.S. Cl. 204/424

(57) ABSTRACT

An oxygen sensor including an oxygen concentration sensing unit including a pair of electrodes and a solid electrolyte layer which is disposed between the pair of electrodes and has an oxygen ion conductivity. A porous protective coat is disposed on an outer surface of the oxygen concentration sensing unit. A protector covers the oxygen concentration sensing unit via a space between the protector and the porous protective coat and has a plurality of inlet holes through which a gas to be measured is introduced into the space. A ratio of a thickness of the porous protective coat to a diameter of each of the plurality of inlet holes is in a range of from 5% to 50%.

### BACKGROUND OF THE INVENTION

The present invention relates to an oxygen sensor, and specifically to an oxygen sensor for sensing oxygen concentration in exhaust gas from a vehicle engine.

Conventionally, there have been proposed various oxygen sensors. Japanese Patent Application First Publication No. 9-222416, corresponding to U.S. Pat. No. 5,762,771, describes an oxygen sensor useable in an exhaust system of a vehicle engine. The oxygen sensor includes a base, a heater pattern on the base, and an oxygen concentration sensing portion which includes a pair of electrodes and an oxygen-ion conducting solid electrolyte layer between the solid electrolyte layer. The solid electrolyte layer is activated by energizing the heater pattern for heating the solid electrolyte layer to thereby produce a potential difference between the electrodes and detect concentration of oxygen in exhaust gas in an exhaust pipe of the exhaust system. The oxygen sensor further includes a protector for protecting the oxygen concentration sensing portion which has a double-wall structure constituted of an inner protecting cover and an outer protecting cover. The inner and outer protecting covers are formed with inlet holes through which the exhaust gas to be measured is introduced to an inside of the protector.

Depending on engine operating conditions, water vapor in the exhaust gas is condensed and liquefied into water in the exhaust pipe in which the conventional oxygen sensor as described above is provided, and then adhered to an outer periphery of the protector. If a large amount of the condensed water is adhered to the outer periphery of the protector, the condensed water adhered will enter the inside of the protector through the inlet holes of the protector. It is likely that the condensed water then is contacted with the oxygen concentration sensing portion of the oxygen sensor in a high temperature condition to thereby cause damage such as a crack in the oxygen concentration sensing portion.

In order to prevent the condensed water from entering the inside of the protector, the oxygen sensor of the above conventional art includes the protector having the double-wall structure in which the inner and outer protecting covers are located in a relative position in which the inlet holes of the inner protecting cover and the inlet holes of the outer protecting covers are circumferentially offset from each other.

### SUMMARY OF THE INVENTION

However, even in the oxygen sensor of the above conventional art, there is a risk that the oxygen concentration sensing portion suffers from damage due to the condensed water which enters the inside of the protector and adheres to the oxygen concentration sensing portion, depending on engine operating conditions.

It is an object of the present invention to provide an oxygen sensor which can be prevented from suffering from damage in the oxygen concentration sensing portion due to the condensed water adhered thereto and can maintain the response performance with respect to detection of oxygen concentration.

The other objects and features of this invention will become understood from the following description with reference to the accompanying drawings.

In one aspect of the present invention, there is provided an oxygen sensor comprising:
an oxygen concentration sensing unit including a pair of electrodes and a solid electrolyte layer which is disposed between the pair of electrodes and has an oxygen ion conductivity;
a porous protective coat disposed on an outer surface of the oxygen concentration sensing unit; and
a protector covering the oxygen concentration sensing unit via a space between the protector and the porous protective coat, the protector being formed with a plurality of inlet holes through which a gas to be measured is introduced into the space between the protector and the porous protective coat,
wherein a ratio of a thickness of the porous protective coat to a diameter of each of the plurality of inlet holes is in a range of from 5% to 50%.

In a further aspect of the present invention, there is provided an oxygen sensor comprising:
an oxygen concentration sensing unit including a pair of electrodes and a solid electrolyte layer which is disposed between the pair of electrodes and has an oxygen ion conductivity;
a porous protective coat disposed on an outer surface of the oxygen concentration sensing unit; and
a protector covering the oxygen concentration sensing unit via a space between the protector and the porous protective coat, the protector being formed with a plurality of inlet holes through which a gas to be measured is introduced into the space between the protector and the porous protective coat,
wherein the porous protective coat has a porosity in a range of from 30% to 70%.

In a still further aspect of the present invention, there is provided an oxygen sensor comprising:
an oxygen concentration sensing unit including a pair of electrodes and a solid electrolyte layer which is disposed between the pair of electrodes and has an oxygen ion conductivity;
a porous protective coat disposed on an outer surface of the oxygen concentration sensing unit; and
a protector covering the oxygen concentration sensing unit via a space between the protector and the porous protective coat, the protector being formed with a plurality of inlet holes through which a gas to be measured is introduced into the space between the protector and the porous protective coat,
wherein the plurality of inlet holes each have a diameter in a range of from 0.5 mm to 2.0 mm, and the protective coat has a thickness in a range of from 50 μm to 400 μm.

### BRIEF DESCRIPTION OF THE DRAWINGS

FIG. 1 is a sectional view of an oxygen sensor of an embodiment of the present invention, taken in an axial direction of the oxygen sensor.

FIG. 2 is a cross-sectional view of an oxygen detecting portion of the oxygen sensor shown in FIG. 1, taken along line 2-2 shown in FIG. 1.

FIG. 3 is a graph showing a preferred range of a ratio between a thickness of a protective layer of the oxygen sensor and a diameter of each inlet hole formed in a protector of the oxygen sensor.

### DETAILED DESCRIPTION OF THE INVENTION

An embodiment of the present invention will now be described in detail with reference to the accompanying drawings. An oxygen sensor of this embodiment is mounted to an exhaust pipe of an automobile equipped with an internal combustion engine and used for detecting an air-fuel ratio.

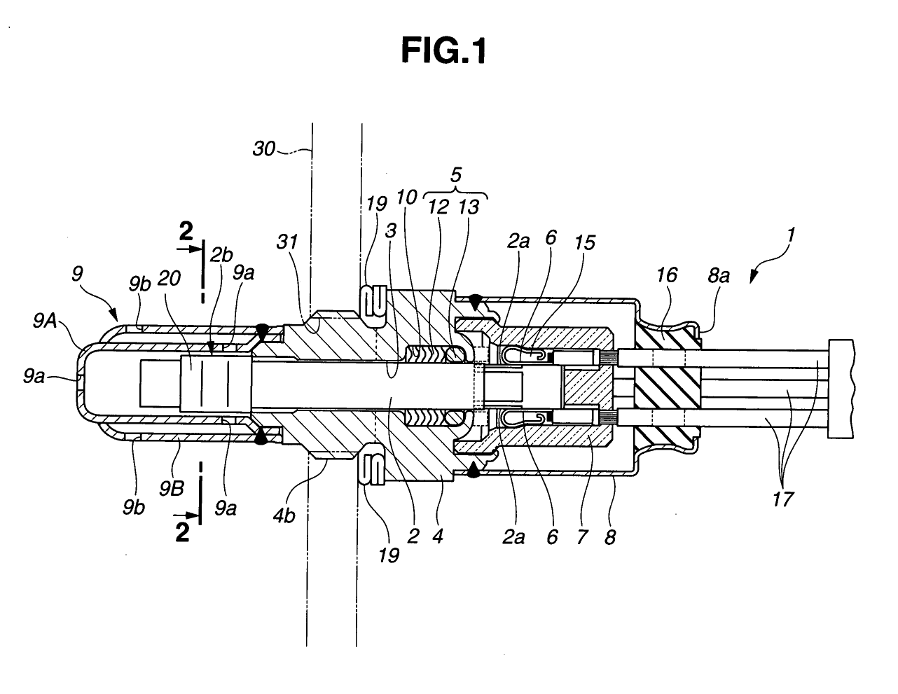

FIG. 1 is a section of an oxygen sensor of this embodiment, taken in an axial direction of the oxygen sensor. As illustrated in FIG. 1, oxygen sensor 1 is mounted to exhaust pipe 30 of the automobile. Oxygen sensor 1 includes cylindrical rod-shaped sensor element 2, holder 4 for retaining sensor element 2, and protector 9 for protecting sensor element 2. Holder 4 is formed with cylindrical-shaped element insertion bore 3 into which sensor element 2 is inserted. Sensor element 2 extends through element insertion bore 3 and outwardly projects from opposed axial end faces of holder 4. Sensor element 2 includes electrode 2a at one axial end thereof and oxygen detecting portion 2b at the other axial end thereof. Protector 9 covers oxygen detecting portion 2b of sensor element 2 in a spaced relation to oxygen detecting portion 2b.

Protector 9 has a tubular shape with a closed end and is fixed to an axial end portion of holder 4 which is located on the side of electrode 2a of sensor element 2, by a suitable method, such as welding, caulking or the like. Protector 9 has a double-walled structure which is constituted of inner protector 9A and outer protector 9B. There exists-an inside space between inner protector 9A and oxygen detecting portion 2b of sensor element 2. Inner protector 9A and outer protector 9B are formed with a plurality of inlet holes 9a and 9b, respectively. An exhaust gas to be measured is introduced into the inside space of protector 9 through inlet holes 9a and 9b and reaches around oxygen detecting portion 2b of sensor element 2. In this embodiment, eight inlet holes 9a and 9b are formed, each having a circular shape.

Seal 5 is disposed within increased-diameter portion 10 of element insertion bore 3 of holder 4 which is located on the side of electrode 2a of sensor element 2. Seal 5 is filled in a clearance between a circumferential surface of increased-diameter portion 10 and an outer circumferential surface of sensor element 2 to thereby hermetically seal the clearance. Seal 5 includes ceramic powder 12, for instance, unsintered talc, and spacer 13, for instance, a washer. Upon filling the clearance, ceramic powder 12 is filled in increased-diameter portion 10 of element insertion bore 3 and then compacted using spacer 13.

Terminal support 7 for retaining terminals is fixed to the other axial end portion of holder 4 which is located on the side of electrode 2a of sensor element 2. Terminal support 7 is made of glass-and formed into a cylindrical shape with a closed end. Terminal support 7 covers electrode 2a of sensor element 2. Tubular casing 8 is arranged so as to cover terminal support 7 with a predetermined clearance between an inner circumferential surface of tubular casing 8 and an outer circumferential surface of terminal support 7. One axial end portion of tubular casing 8 is fixed to an outer circumferential surface of the other axial end portion of holder 4 by a suitable method such as laser welding (so-called laser welding-all-around) or the like. Thus, casing 8 and holder 4 are connected together in a hermetically sealed relation to each other.

The other axial end portion of casing 8 is filled with generally cylindrical seal rubber 16. Seal rubber 16 is fixed to the other axial end portion of casing 8 by caulking portion 8a of casing 8. A plurality of leads 17, four leads in this embodiment, are drawn from casing 8 through seal rubber 16. Seal rubber 16 ensures a hermetical seal between leads 17 and the other axial end portion of casing 8. Preferably, seal rubber 16 is made of a high heat-resistant material, for instance, fluororubber.

Each of leads 17 has one end connected with terminal 6 which is retained inside terminal support 7 thereby. Terminal 6 is configured to be a resilient body and surely contacted with electrode 2a on an outer peripheral surface of sensor element 2 by the resilient force. This can ensure continuity between electrode 2a and terminal 6.

Thus constructed oxygen sensor 1 is fixedly mounted to exhaust pipe 30 by screwing threaded portion 4b of holder 4 into tapped hole 31 which is formed in a circumferential wall of exhaust pipe 30. In the mounted state of oxygen sensor 1, a portion of oxygen sensor 1 which is covered with protector 9 is projected into an exhaust passage in exhaust pipe 30. Gasket 19 is disposed between a flange of holder 4 and an outer surface of exhaust pipe 30 and seals a clearance therebetween.

Internal space 15 of oxygen sensor 1 which is formed between sensor element 2, holder 4 and terminal support 7, is prevented from being fluidly communicated with an outside of oxygen sensor 1 with cooperation of seal 5, seal rubber 16 and the hermetical connection at the axial end portions of holder 4 and casing 8, except for the slight communication through an extremely fine space in each of leads 17. For instance, the extremely fine space is constituted of a clearance between a core and a coat of lead 17.

When an exhaust gas passing through exhaust pipe 30 flows into the inside space of oxygen sensor 1 between oxygen detecting portion 2b of sensor element 2 and inner protector 9A through inlet holes 9a of inner protector 9A and inlet holes 9b of outer protector 9B, oxygen in the exhaust gas enters oxygen detecting portion 2b. Oxygen concentration of the exhaust gas is detected by oxygen detecting portion 2b and converted into an electric signal indicative of the oxygen concentration detected. The electric signal is then outputted via electrode 2a, terminals 6 and leads 17.

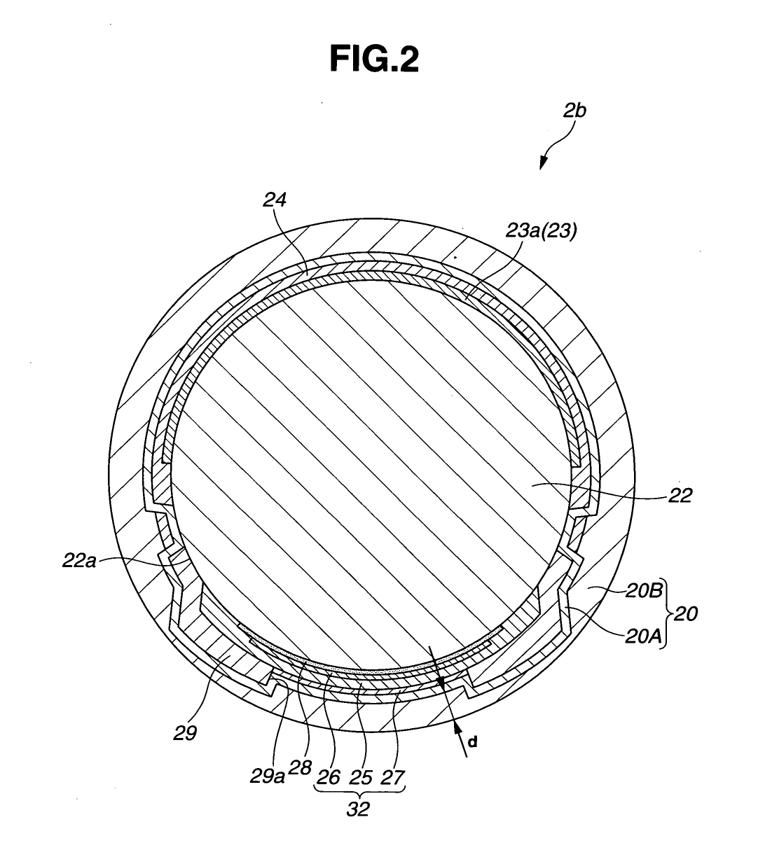

Referring to FIG. 2, oxygen detecting portion 2b of sensor element 2 is explained in detail. As illustrated in FIG. 2, oxygen detecting portion 2b includes solid core rod 22 serving as a base member, heater pattern 23 disposed on circumferential outer surface 22a of solid core rod 22, and heater insulating layer 24 covering an entire outer surface of heater pattern 23. Oxygen detecting portion 2b further includes solid electrolyte layer 25 which has oxygen-ion conductivity and is disposed in a position radially opposed relation to heater pattern 23 on outer surface 22a of solid core rod 22 via inner electrode 26 and stress damping layer 28. Inner electrode 26 is disposed on an inner surface of solid electrolyte layer 25 and serves as a reference electrode. Stress damping layer 28 is disposed between outer surface 22a of solid core rod 22 and an inner surface of inner electrode 26. Outer electrode 27 is disposed on an outer surface of solid electrolyte layer 25 and serves as a detecting electrode. Solid electrolyte layer 25 thus is disposed between inner electrode 26 and outer electrode 27. Solid electrolyte layer 25, inner electrode 26 and outer electrode 27 cooperate to form oxygen concentration sensing unit 32 as explained later. Dense layer 29 with a window is disposed on the outer surface of solid electrolyte layer 25 and the outer surface of outer electrode 27.

Porous protective coat 20 is disposed on an outer surface of oxygen concentration sensing unit 32 and covers oxygen concentration sensing unit 32. Porous protective coat 20 includes at least a porous spinel protective layer and may be of either a single layer structure or a multi-layered structure. In this embodiment, porous protective coat 20 has a dual-layered structure which includes inner porous protective layer 20A and outer porous protective layer 20B which is the porous spinel protective layer. Inner porous protective layer 20A is disposed on oxygen concentration sensing unit 32, dense layer 29 and heater insulating layer 24 and extends along the whole circumference of oxygen detecting portion 2b. Outer porous protective layer 20B is disposed on inner porous protective layer 20A and covers inner porous protective layer 20A. Inner porous-protective layer 20A thus is disposed between oxygen concentration sensing unit 32 and outer porous protective layer 20B. There exists a space between a circumferential outer surface of outer porous protective layer 20B and a circumferential inner surface of inner protector 9A, into which the exhaust gas to be measured is introduced through inlet holes 9a and 9b of inner and outer protectors 9A and 9B.

Specifically, solid core rod 22 is made of an electrically insulating material, for instance, a ceramic material such as alumina, and formed into a cylindrical rod shape. Heater pattern 23 is made of an exothermic and conductive material, such as tungsten and platinum, which generates heat upon being energized. Heater pattern 23 is connected with two of four leads 17. When heater pattern 23 is energized through the two leads 17, heater portion 23a of heater pattern 23 produces heat to cause temperature rise of solid electrolyte layer 25 via solid core rod 22, and thereby activate solid electrolyte layer 25. Heater insulating layer 24 is made of an electrically insulating material and electrically insulates heater pattern 23 from the surrounding portions.

Solid electrolyte layer 25 is formed by patterning a paste material and then baking the patterned paste material. The paste material may be made from a mixture which is prepared by blending zirconia powder with a predetermined weight % of yttria powder. When activated, solid electrolyte layer 25 generates an electromotive force between inner electrode 26 and outer electrode 27 which varies depending on a difference in oxygen concentration between inner electrode 26 and outer electrode 27. This causes oxygen ions to move through solid electrolyte layer 25 in a direction of a thickness of solid electrolyte layer 25. Thus, solid electrolyte layer 25, inner electrode 26 and outer electrode 27 cooperate to form oxygen concentration sensing unit 32 for converting the difference in oxygen concentration to the corresponding electric signal. Oxygen concentration sensing unit 32 is arranged radially diametrically opposed to heater pattern 23 on circumferential outer surface 22a of solid core rod 22.

Each of inner electrode 26 and outer electrode 27 is made of a metal material which has an electrical conductivity and an oxygen gas permeability, for instance, platinum. Inner electrode 26 and outer electrode 27 are connected with the remaining two of the four leads 17, respectively. An output voltage produced between inner electrode 26 and outer electrode 27 is taken out through the two of leads 17 and measured. In this embodiment, inner electrode 26 is formed by patterning a paste material made from a mixture of noble metal, e.g., platinum, and a pore forming agent, e.g., theobromine and then baking the patterned paste material. The pore forming agent is burned out and removed from the material to thereby produce pores in the material during baking the patterned paste material. Thus, inner electrode 26 is formed into a porous structure.

Stress damping layer 28 is formed by patterning a paste material which is made by blending a mixture of zirconia and aluminum with a pore forming agent, for instance, carbon, and then baking the patterned material. Thus, stress damping layer 28 has a porous structure and permits the oxygen gas introduced into inner electrode 26 through solid electrolyte layer 25 to flow into stress damping layer 28. Stress damping layer 28 acts for reducing a difference in thermal stress between solid electrolyte layer 25 and solid core rod 22 which will occur during the heat treatment.

Dense layer 29 is made of such a material as a ceramic material, e.g., alumina, which prevents oxygen in the exhaust gas to be measured from permeating therethrough. Dense layer 29 with the window covers the entire outer surface of solid electrolyte layer 25 except for a portion of the outer surface of solid electrolyte layer 25 which is exposed to the exhaust gas to be measured through the window, via outer electrode 27, inner porous protective layer 20A and outer porous protective layer 20B. Oxygen in the exhaust gas to be measured is permitted to enter outer electrode 27 through only the window of dense layer 29.

Inner porous protective layer 20A is disposed on an outer surface of dense layer 29, an outer surface of heater insulating layer 24 and an outer surface of outer electrode 27 which is exposed through the window of dense layer 29. Inner porous protective layer 20A is made of a porous material that prevents harmful gases and dusts in the exhaust gas to be measured from permeating therethrough, but allows oxygen in the exhaust gas to be measured to permeate therethrough. The porous material may be formed from a mixture of alumina and magnesium oxide. Inner porous protective layer 20A may be formed by screen-printing.

Outer porous protective layer 20B is disposed on a circumferential outer surface of inner porous protective layer 20A and covers the entire area of the circumferential outer surface of inner porous protective layer 20A. Outer porous protective layer 20B includes a porous spinel protective layer. Outer porous protective layer 20B is made of a porous material that allows oxygen in the exhaust gas to be measured to permeate therethrough. Outer porous protective layer 20B is coarser in porosity than inner porous protective layer, namely, has a porosity greater than that of inner porous protective layer 20A.

On the basis of the study on durability of the above-discussed oxygen sensor 1 when the condensed water is adhered to oxygen concentration sensing unit 32, it has been found that sensing ability of oxygen concentration sensing unit 32 can be ensured and also durability thereof against the condensed water adhered thereto can be enhanced by suitably adjusting ratio d/D of thickness d shown in FIG. 2 of outer porous protective layer 20B, i.e., thickness d of the porous spinel protective layer, to diameter D of each of inlet holes 9a of at least inner protector 9A of protector 9. In this embodiment, ratio d/D is adjusted to the range of from 5% to 50%.

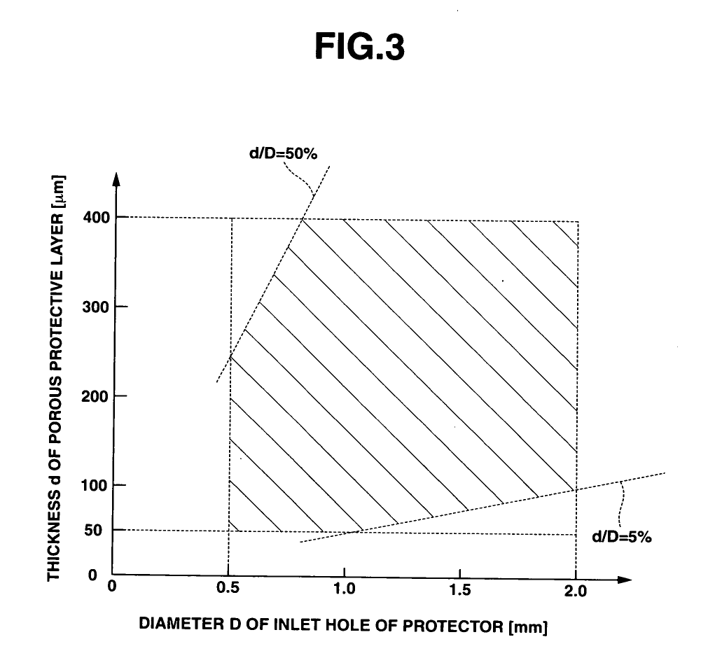

Referring to FIG. 3, a relationship between durability of oxygen concentration sensing unit 32 and ratio d/D of thickness d of outer porous protective layer 20B to diameter D of inlet hole 9a is explained. When ratio d/D is larger than 50%, thickness d of outer porous protective layer 20B is too large with respect to diameter D of inlet hole 9a. Namely, thickness d of outer porous protective layer 20B is excessively large with respect to a flow amount of the exhaust gas to be measured which is introduced into the inside space of inner protector 9A through inlet holes 9a. The flow amount of the exhaust gas to be measured increases with increase in diameter D of inlet hole 9a. Due to the excessively large thickness d of outer porous protective layer 20B, the flow of the exhaust gas to be measured is prevented from permeating through oxygen concentration sensing unit 32. This leads to deterioration of detection response of oxygen concentration sensing unit 32, whereby the response necessary to control the engine, for instance, response with delay of about 200 ms or less, cannot be ensured.

In contrast, when ratio d/D is smaller than 5%, thickness d of outer porous protective layer 20B is too small with respect to diameter D of inlet hole 9a. This causes lack in thickness d of outer porous protective layer 20B with respect to an amount of the condensed water which enters the inside space of inner protector 9A through inlet hole 9a. The lack in thickness d of outer porous protective layer 20B will cause damage such as a crack in oxygen concentration sensing unit 32. By adjusting ratio d/D to the range of from 5% to 50%, the detection response of oxygen concentration sensing unit 32 can be ensured, and oxygen concentration sensing unit 32 can be prevented from suffering from damage which would be caused by the condensed water adhered thereto in a high temperature condition. Therefore, the durability of oxygen concentration sensing unit 32 relative to the condensed water adhered thereto can be enhanced.

Further, it has been found that the sensing ability of oxygen concentration sensing unit 32 can be ensured and the durability thereof against the condensed water adhered thereto can be enhanced by suitably adjusting diameter D of inlet hole 9a and thickness d of outer porous protective layer 20B. In this embodiment, diameter D of inlet hole 9a is adjusted to the range of from 0.5 mm to 2 mm, and thickness d of outer porous protective layer 20B is adjusted to the range of from 50 μm to 400 μm.

Specifically, if diameter D of inlet hole 9a is smaller than 0.5 mm, a flow of the exhaust gas to be measured will be prevented from flowing into the inside space of inner protector 9A through inlet holes 9a. This will cause deterioration in detection response of oxygen concentration sensing unit 32 to thereby fail to ensure the response necessary to control the engine. On the other hand, if diameter D of inlet hole 9a is larger than 2 mm, an amount of the condensed water entering the inside space of inner protector 9A through inlet hole 9a will be excessively increased. This leads to occurrence of damage such as a crack in oxygen concentration sensing unit 32.

If thickness d of outer porous protective layer 20B as shown in FIG. 2 is smaller than 50 μm, oxygen concentration sensing unit 32 cannot be surely protected from the condensed water entering the inside space of inner protector 9A through inlet hole 9a and will suffer from damage such as a crack. On the other hand, if thickness d of outer porous protective layer 20B is larger than 400 μm, a flow of the exhaust gas to be measured will be prevented from permeating through oxygen concentration sensing unit 32.

This leads to deterioration in detection response of oxygen concentration sensing unit 32, whereby the detection response necessary to control the engine ensure cannot be ensured.

By adjusting diameter D of inlet hole 9a to the range of from 0.5 mm to 2 mm and adjusting thickness d of outer porous protective layer 20B to the range of from 50 μm to 400 μm, the detection response of oxygen concentration sensing unit 32 can be ensured, and oxygen concentration sensing unit 32 can be prevented from suffering from damage which would be caused by the condensed water adhered thereto. Accordingly, the sensing ability of oxygen concentration sensing unit 32 can be ensured, and the durability thereof against the condensed water adhered thereto can be enhanced.

FIG. 3 illustrates ratio d/D in the range of from 5% to 50%, diameter D of inlet hole 9a in the range of from 0.5 mm to 2 mm and thickness d of outer porous protective layer 20B in the range of from 50 μm to 400 μm, as indicated by hatching.

Further, it has been found that the sensing ability of oxygen concentration sensing unit 32 can be ensured and the durability thereof with respect to the condensed water adhered thereto can be enhanced by suitably adjusting porosity of outer porous protective layer 20B. In this embodiment, the porosity of outer porous protective layer 20B, i.e., the porosity of the porous spinel protective layer, is adjusted to the range of from 30% to 70%.

If the porosity of outer porous protective layer 20B is less than 30%, a rate of permeation of the exhaust gas to be measured with respect to outer porous protective layer 20B will be reduced. This leads to deterioration in detection response of oxygen concentration sensing unit 32, so that the detection response necessary to control the engine ensure cannot be ensured. On the other hand, if the porosity of outer porous protective layer 20B is less than 70%, the condensed water entering the inside space of inner protector 9A through inlet hole 9a will permeate through outer porous protective layer 20B. Therefore, oxygen concentration sensing unit 32 will suffer from damage such as a crack due to the condensed water. By adjusting the porosity of outer porous protective layer 20B to the range of from 30% to 70%, the detection response of oxygen concentration sensing unit 32 and the sensing ability thereof can be ensured, and the durability thereof with respect to the condensed water adhered thereto can be enhanced. Further, the flowing speed of the exhaust gas to be measured which reaches oxygen concentration sensing unit 32 through outer porous protective layer 20B can be controlled to prevent oxygen concentration sensing unit 32 from suffering from damage due to the condensed water adhered thereto. Table 1 shows the above facts relative to the ranges of the porosity of outer porous protective layer 20B.

TABLE 1

| | Range of Porosity | | |
|---|---|---|---|
| | 0-30 | 30-70 | greater than 70 |
| Effect on Sensing Ability | Not Good | Good | Not Good |
| and Durability of Oxygen | | | |
| Concentration Sensing Unit | | | |

Furthermore, the materials and compositions of the respective layers as described above and the methods of forming the respective layers are not limited to the above embodiment. The respective layers may be made of any other materials and compositions and may be formed by any other methods as long as the same functions and effects as explained in the above embodiment are obtained. Further, the parts of oxygen sensor 1 except for inner and outer porous protective layers 20A and 20B and protector 9 may be suitably modified in material, composition and production method.

This application is based on a prior Japanese Patent Application No. 2005-304378 filed on Oct. 19, 2005. The entire contents of the Japanese Patent Application No. 2005-304378 is hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. An oxygen sensor comprising:
an oxygen concentration sensing unit including a pair of electrodes and a solid electrolyte layer which is disposed between the pair of electrodes and has an oxygen ion conductivity;
a porous protective coat disposed on an outer surface of the oxygen concentration sensing unit; and
a protector covering the oxygen concentration sensing unit via a space between the protector and the porous protective coat, the protector being formed with a plurality of inlet holes through which a gas to be measured is introduced into the space between the protector and the porous protective coat,
wherein a ratio of a thickness of the porous protective coat to a diameter of each of the plurality of inlet holes is in a range of from 5% to 50%.

2. The oxygen sensor as claimed in claim 1, wherein the porous protective coat comprises a porous spinel protective layer.

3. The oxygen sensor as claimed in claim 2, wherein the porous protective coat has a thickness in a range of from 50 μm to 400 μm.

4. The oxygen sensor as claimed in claim 2, wherein the porous protective coat further comprises an inner porous protective layer which is disposed between the oxygen concentration sensing unit and the porous spinel protective layer.

5. The oxygen sensor as claimed in claim 1, wherein the plurality of inlet holes each have a diameter in a range of from 0.5 mm to 2.0 mm.

6. An oxygen sensor comprising:
an oxygen concentration sensing unit including a pair of electrodes and a solid electrolyte layer which is disposed between the pair of electrodes and has an oxygen ion conductivity;
a porous protective coat disposed on an outer surface of the oxygen concentration sensing unit; and
a protector covering the oxygen concentration sensing unit via a space between the protector and the porous protective coat, the protector being formed with a plurality of inlet holes through which a gas to be measured is introduced into the space between the protector and the porous protective coat,
wherein the porous protective coat has a porosity in a range of from 30% to 70%.

7. The oxygen sensor as claimed in claim 6, wherein the porous protective coat comprises a porous spinel protective layer which has a porosity in a range of from 30% to 70%.

8. The oxygen sensor as claimed in claim 7, wherein the porous protective coat further comprises an inner porous protective layer which is disposed between the oxygen concentration sensing unit and the porous spinel protective layer.

9. The oxygen sensor as claimed in claim 8, wherein the porous spinel protective layer is coarser in porosity than the inner porous protective layer.

10. An oxygen sensor comprising:
an oxygen concentration sensing unit including a pair of electrodes and a solid electrolyte layer which is disposed between the pair of electrodes and has an oxygen ion conductivity;
a porous protective coat disposed on an outer surface of the oxygen concentration sensing unit; and
a protector covering the oxygen concentration sensing unit via a space between the protector and the porous protective coat, the protector being formed with a plurality of inlet holes through which a gas to be measured is introduced into the space between the protector and the porous protective coat,
wherein the plurality of inlet holes each have a diameter in a range of from 0.5 mm to 2.0 mm, and the protective coat has a thickness in a range of from 50 μm to 400 μm.

11. The oxygen sensor as claimed in claim 10, wherein the protector has a double-wall structure which is constituted of an inner protector and an outer protector, and at least the inner protector has the plurality of inlet holes each having the diameter in the range of from 0.5 mm to 2.0 mm.

12. The oxygen sensor as claimed in claim 10, wherein the porous protective coat comprises a porous spinel protective layer.

13. The oxygen sensor as claimed in claim 12, wherein the porous protective coat further comprises an inner porous protective layer which is disposed between the oxygen concentration sensing unit and the porous spinel protective layer.
